(19) United States
(12) Patent Application Publication
(10) Pub. No.: US 2010/0226487 A1
(43) Pub. Date: Sep. 9, 2010

(54) METHOD & APPARATUS FOR CONTROLLING THE STATE OF A COMMUNICATION SYSTEM

(75) Inventors: Rob Harder, Vancouver (CA); Ara Bedrossian, Burnaby (CA); Geraldine Maclear, Burnaby (CA); Vladimir Mikulaj, Vancouver (CA); Yu Xin, Shenzhen (CN); Ted Becker, Burnaby (CA); Eric David Elias, Somerville, MA (US); Jeffrey C. Rodman, San Francisco, CA (US)

Correspondence Address: ROBERT C. SCHLUER, 45 GROTON ROAD, SHIRLEY, MA, 01464, US

(73) Assignee: Polycom, Inc., Pleasanton, CA (US)

(21) Appl. No.: 12/718,762

(22) Filed: Mar. 5, 2010

Related U.S. Application Data
(60) Provisional application No. 61/158,493, filed on Mar. 9, 2009.

(51) Int. Cl. H04M 3/42

(52) U.S. Cl. 379/202.01

(57) ABSTRACT

A networked conferencing device includes at least one speaker, a display and a plurality of environmental sensors such as cameras, microphones, light level sensors, thermal sensors and motion sensors. The conferencing device receives environmental information from the sensors and processes this information to identify qualified events. The identified qualified events are then used to determine a next powered state for the conferencing device. If the next powered state is different than a current powered state, then the conferencing system transitions to the next powered state.

### CROSS REFERENCE TO RELATED APPLICATIONS

This application claims the benefit under 35 U.S.C. §119(e) of U.S. Provisional Patent Application Ser. No. 61/158,493 entitled “Use of Motion Detection for Power Savings in a Video Conferencing Device”, filed Mar. 9, 2009, the entire contents of which is incorporated by reference.

### FIELD

The invention relates generally to the area of controlling the state of an electronic system and specifically to using information received by one or more environmental sensors to control the state of a communication device.

### BACKGROUND

Environmental control systems have been in existence for some time which operate to automatically control the temperature or the lighting in a room environment. Thermostats can be set to automatically turn on or off a heating system depending upon certain pre-set threshold temperatures. Motion sensing systems can be placed in rooms that detect the presence or absence of people in the room and which operate to automatically turn on or turn off the room lighting.

Many electronic devices, whether they are battery operated or not, can be placed into a lower powered mode from a higher powered mode of operation or state in order to conserve battery-life, electricity or the operational integrity of a component part, or can be placed into a higher powered state from a lower powered state in order to be used. A mobile phone, for instance, typically includes functionality that places it into a lower powered state in which its display and LEDs are powered down after some pre-determined period of inactivity. This inactivity can be determined using a number of different qualified events such as the cessation of voice activity, the absence of device movement or the temperature of the device. Computational devices, such as laptop or desktop computers, also include power conservation functionality that operates to determine their state. Such devices typically include a state in which they are fully operational, a state in which they are not fully operational (sleep) but not turned off and other operation states. Entry into or exit from either of these states can be determined based on information or input received by these devices from an individual using them. So for instance, computer devices can transition to a sleep mode after some preset period of inactivity which can be measured from the last keyboard stroke or the last verbal command and they can operate to transition to a fully operational mode when an operator depresses a key on the keyboard or interacts with the device in some other manner.

Some mobile communication devices can include one or more sensors, each of which is capable of receiving different environmental information. In addition to inactivity sensors, a mobile communication device can include one sensor to receive positional information, a second sensor to receive device motion information, a third sensor to receive light information, and a fourth sensor to receive temperature information. The information sensed by any of the multiple sensors can be compared to some pre-set or dynamic threshold to determine whether the device is in use or not and the device state can be changed accordingly.

Prior art techniques employed with mobile communication devices or computers can effect changes in the state of these devices based upon environmental information received by only a single sensor, whether there are more than one sensors are connected to the device or not. Other prior art techniques effect changes in the state of an electronic device based upon a users physical interaction with a device.

Video conferencing systems and devices comprise a class of network communication device in which for various reasons it is desirable to control system state. Depending upon the size of the room in which they operate and the application for which the systems are used, video conferencing systems and devices can be implemented with, among other things, one or more video monitors, one or more speakers, one or more cameras and one or more microphones. Such conferencing systems can use more or less energy depending upon their size and sophistication and, in the event that some system modules, such as microphones, are battery powered, the life of the batteries can be shortened depending upon the length of time the system is in a particular operational state.

While the prior art techniques may be adequate for controlling the state of certain classes of electronic devices, such as mobile phones or computers, these device state control techniques are not sophisticated enough to control the state of a video conferencing system or its peripheral devices such that the device automatically transitions to an appropriate state according to information it receives from its environment. So in the event that users are proximate to the device and want to use the device, the device is able to automatically transition to a useful state which can mean that it applies power to some or all of its component parts.

### SUMMARY

In order to maximize energy savings associated with running a conferencing device and to maximize the component life of the conferencing device, it was discovered that analyzing the input from more than one environmental sensor connected to a conferencing system at the same time more accurately determines the proper action to take to controlling the conferencing device state. As the result of this analysis, power can be applied to or withdrawn from a selected few or all of the conferencing system component parts. In another embodiment, it was discovered that the input from certain sensor components can be weighted more heavily than the input from other sensor components, and that this differential weighting can be used to determine the correct state of the conferencing system. In yet another embodiment, it was discovered that the weighted inputs from a plurality of sensor components can be processed and summed, and that if the total value of all of the processed and weighted sensor input is greater than a pre-determined threshold value, that the conferencing system can be placed into a particular state. In another embodiment, it was discovered that image information captured by a camera connected to a conferencing device can be employed to detect motion and trigger the activation of conferencing system component parts. And finally, in another embodiment, a sound source that is proximate to a conferencing device is discriminated from sound that is not proximate to the conferencing device, and this environmental information is employed to determine the state of the conferencing device.

### BRIEF DESCRIPTION OF THE FIGURES

FIG. 1 is a diagram showing a video conferencing system used in a typical room environment with its associated peripheral devices and room environmental sensors.

FIG. 2 is a diagram of a video conferencing device suitable for use on a desk or table top.

FIG. 3 is a functional block diagram of a typical video conferencing system that is connected to a network.

FIG. 4 is a diagram of the automatic state control module of FIG. 3.

FIG. 5 is a logical flow diagram of a motion detection algorithm.

FIG. 6 is a logical flow diagram of the overall process used to control the conferencing system state.

FIG. 7 is a logical flow diagram of a state determination algorithm.

### DETAILED DESCRIPTION

A video conferencing system can be more or less complex depending upon the application in which the system is used and the needs of those using a video conferencing system. Conferencing system are typically configured which employ more than one microphone, several speakers, at least one large video monitor and at least one camera for applications which require multiple audio and video components to monitor more than one individual in a relatively large room setting. On the other hand, systems are typically much less complex for applications in which one individual is likely to use a video conferencing system. For the purpose of this description, both a complex room video conferencing system and a less complex desktop video conferencing device can be referred to as a conferencing device.

The amount of energy used by a conferencing device and the useful life of the component parts of the conferencing device relates directly to the amount of time the component parts are powered and in use. The conferencing device can be in a higher or lower powered state depending upon the relative number of components associated with the device that are powered or not. The higher powered state can be defined as an operational state in which more of the component parts of a conferencing device are powered than are powered in a lower powered state. The powered state of the conferencing device can depend upon the relative amount of power applied to any one of the conferencing device components or any portion of a conferencing device component, it can depend upon the relative speed at which a component is controlled to operate, it can depend upon whether the conferencing device is controlled to be in a communication session or not and it can depend upon the gain applied to any of the device components or it can depend upon a number of other factors. So, if a conferencing system includes three microphones, two cameras, a video and audio codec, and one monitor, and all of these components are powered, then a lower powered state is one in which at least one of the component parts is not powered. Also, if the conferencing device is in a state in which only one microphone and its audio codec are powered, a higher powered state is one in which at least one more component part is powered.

In order to automatically control the state of a conferencing device, whether it is a room video conferencing system or a desk top video conferencing device, the conferencing device receives and processes environmental information from at least one sensor component connected to the conferencing device. Some of this environmental information can be received using standard conferencing device components, such as a video camera or a microphone, and other environmental information can be received using sensors not typically connect to a conferencing device such as light level sensors, thermal sensors, motion sensors, and other sensors. Receiving environmental information from the sensor components other than those normally connected to the conferencing device is a relatively straightforward process, as both conferencing devices and the other sensor components are typically connected to a communication network (local or wide area). Environmental sensors typically connected to a conferencing device such as cameras and microphones, or environmental sensors not typically connected to the conferencing device such as light sensors, motion sensors and heat sensors can be selectively powered (depending upon the current system state) to receive information from the system's environment which can be used by the conferencing device which is used to determine how to control the state of the system or which is used to activate another sensor the input of.

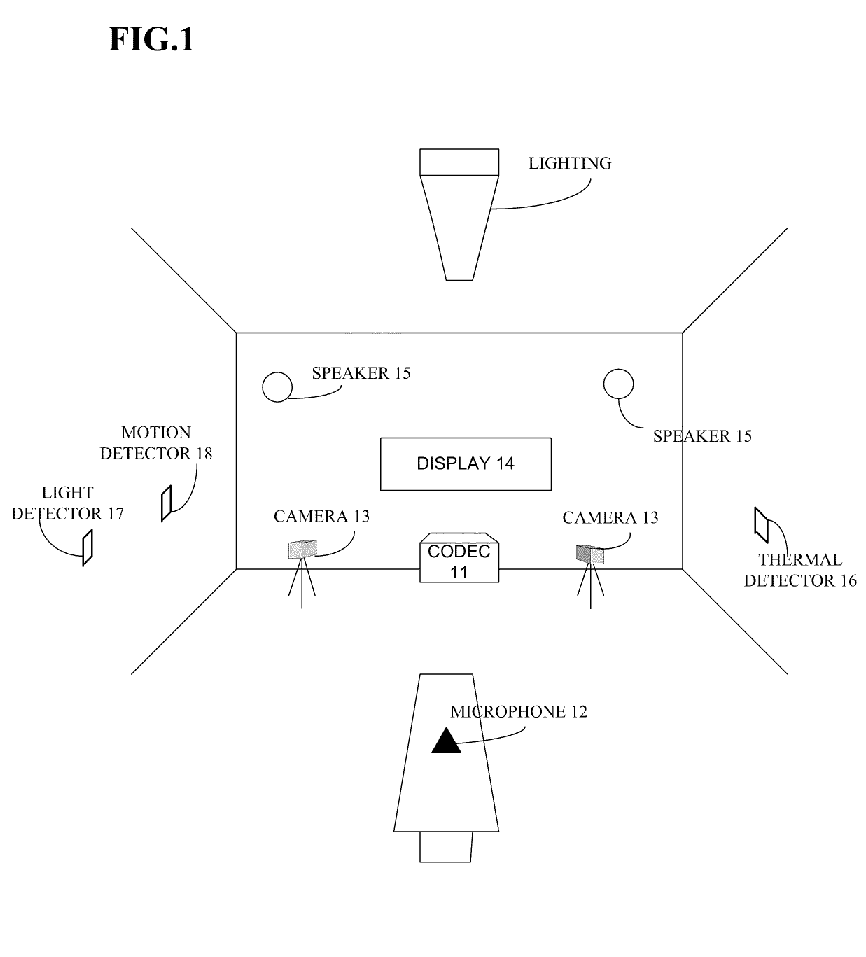

Video conferencing system 10 in FIG. 1 is a complex conferencing system that can be comprised of an audio/video codec 11 and a number of standard component parts for sensing environmental information and component parts for playing audio and video for individuals in the room. The standard video conferencing environmental sensing components can include one or more microphones 12 for receiving audio input from individuals and other sources present in the room or outside the room and one or more video cameras primarily directed to receiving video input from individuals present in the room. The video conferencing system 10 typically also is comprised of two or more speakers 15 strategically positioned in the room and at least one large video monitor 13 which displays far end video for individuals present in the room. Other environmental sensors whose output can be connected over a communication network to the system 10 can include thermal sensors 16 for sensing heat in the infrared frequency range, light level sensors 17 for sensing whether or not the room lighting is turn on and motion sensors 18 for sensing movement in the room.

The conferencing system 10 of FIG. 1 can use a considerable amount of electrical power when all of its component parts are powered and in use, so it is desirable and convenient if, during periods of inactivity, the system 10 can operate to automatically transition into a lower powered state in which some or all of its component parts are not powered. Conversely, it is also desirable and convenient if the system 10 can automatically transition to a higher powered state only when it is determined that individuals are present and would like to use the system 10 for communication. Depending upon the configuration of the system 10 and the environmental information detected by the sensors associated with the system 10, a number of different strategies are employed to determine how to control the state of the system. For example, if the system 10 is in a higher power state (all component parts are powered) and audio energy levels are detected below a threshold frequency for some minimum period of time, and if no movement is detected either in the room or proximate to the one or more microphones, the system 10 can automatically transition to a lower powered state in which only one microphone and the audio codec are powered. In another example, if the system 10 is in the higher powered state (all of the component parts are powered) and the lighting sensor 17 detects that the room lighting is turned off or is below some predetermine threshold level, if the motion sensor 18 or the camera 13 detects movement in the room and the thermal sensor 16 detects at least one heat source in the room, system 10 can automatically transition to a lower powered state by turning off power to the cameras (as it may not be important to transmit near end video to the far end at this point in time). Or, assuming that the system is in a lower powered state in which only one of two or more microphones is active, no cameras are active and the audio codec is turned on but the video codec is turned off. While in this state, the system can determine that individuals may be in the room by detecting both the presence of sound energy above a particular threshold level and above a particular threshold frequency. More specifically, the system can detect a change in the balance between higher and lower frequencies. In the case that sound energy is farther away from the microphone, the sound energy at the higher frequencies is attenuated in relation to the lower frequencies and the system is able to determine that the distance the energy source is from the microphone. As a result, the system can automatically transition from the lower power state to a higher power state by applying power to the video codec and applying power to one of the video cameras. The powered video camera can then receive environmental information in the form of video information and the system 10 use this information to determine that the movement in the room is related to one or more individuals. At the result of the system 10 detecting at least one person in the room, it can automatically transition to a yet higher powered state in which substantially all of its components are powered. In another case, assuming that the system is in a fully operational state or in a minimally operational state and the environmental information received at each sensor is processed resulting in particular values and each of the values are weighted depending upon the particular sensor. The weighted values are added and if the resultant value is greater than a threshold value, the system state is changed to be a lower or higher powered state respectively.

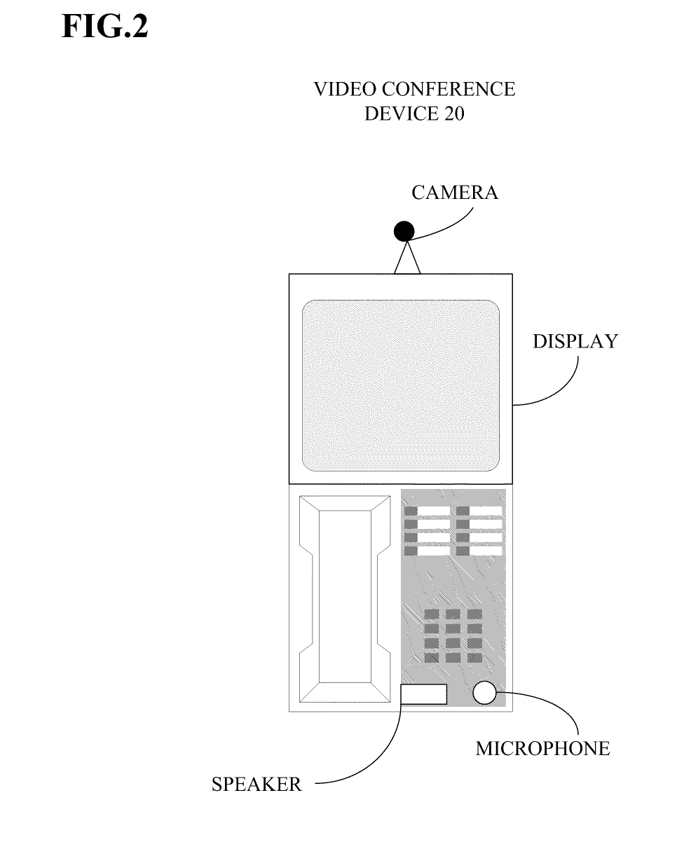

FIG. 2 is a diagram of a desktop conferencing device 20 suitable for use by a single individual. The conferencing device 20 can be comprised of multiple environmental sensors such as a microphone and a video camera and also include a small LCD video display. The device can include video conferencing functionality and other applications that provide useful information, such as the time of day or stock quotes, being continually displayed on the video display. As with the larger, more complex room conferencing system 10 described with reference to FIG. 1, this conferencing device 20 also includes functionality that processes the outputs of the microphone and the video camera and then uses this processed output as input to a state control function that operates automatically to control the state of the device. In this case, the conferencing device 20 can operate in a higher powered and a lower powered state. In the higher powered state, the conferencing device video display is powered on and in the lower powered state the conferencing device video display is powered down. When the conferencing device is in the lower powered state, the device is waiting for a qualified event, which in this case is environmental information indicating that an individual is proximate to the conferencing device (sitting at their desk for instance). Once the qualified event occurs, the conferencing device automatically transitions to the higher powered state and the video display (LCD and backlight in this case) is powered up. The conferencing device remains in the higher powered state for a minimum, predetermined period of time. This predetermined period of time is programmable and can be easily modified. When the minimum period of time expires, the conferencing device automatically transitions to the lower powered state and the video display is powered down. The higher powered state can be maintained or extended if the conferencing device detects qualified events before the predetermined minimum period of time expires. Each qualified event extends the duration of the higher powered state by another minimum period of time. A listing of qualified events is contained in Table I below.

TABLE I
Qualified events triggering transition to
higher or Lower powered state include:

Motion detector senses event
Sound or audio detected proximate to microphone(s)
Change in lighting level
Any key press on the phone
Hook-switch transition
Touch screen interaction
Arrival of a voicemail or IM
Event on externally connected device (through USB)
Arrival of new push content via the XML, API
Local proceeding, active or held call
An alerting call
The instantiation of a new IDNW message (e.g. Network link is down)
A user in proximity to the conferencing device as detected by the camera

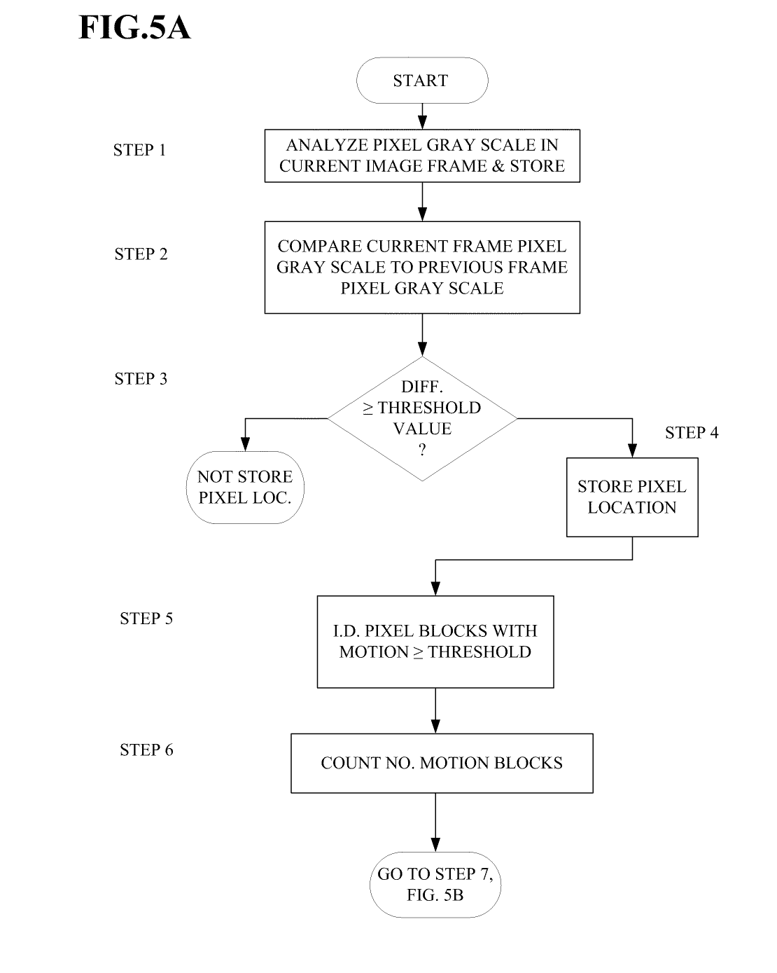

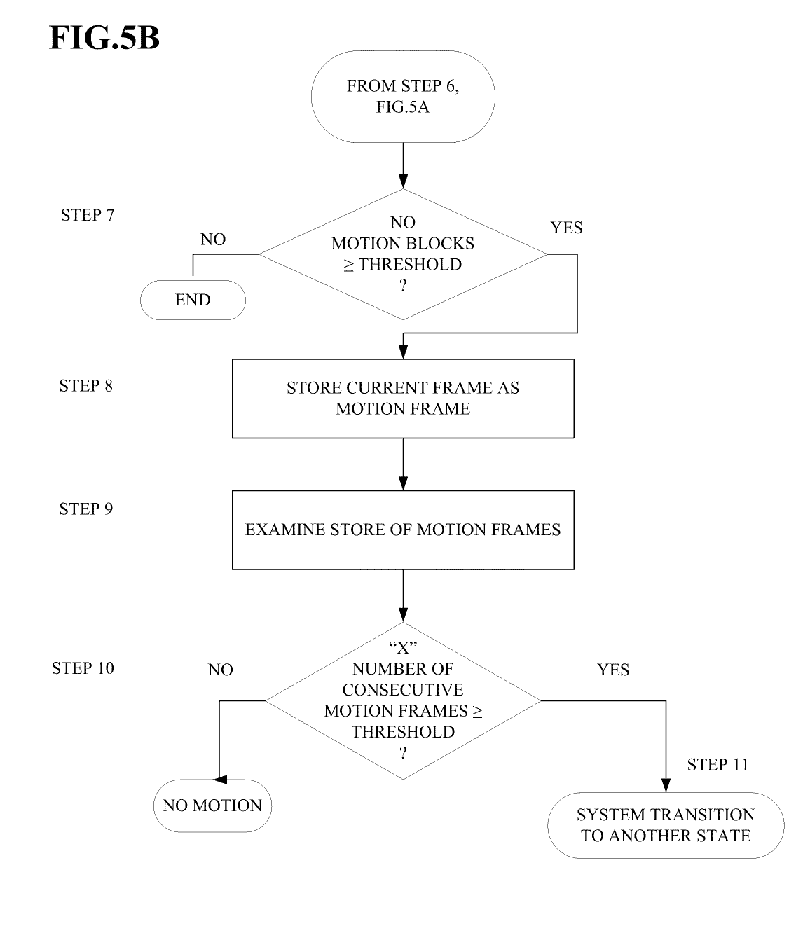

In order to determine that an individual is proximate to the conferencing device, standard video capture functionality is modified to detect motion of an individual proximate to the conferencing device. This motion detection functionality is able to differentiate an individual from background objects in the field of view of the camera. In general, the proximity of a user is estimated by examination of the relative size of moving objects detected in the field of view of the camera. A number of proximity thresholds can be set by adjusting parameters comprising a motion detection algorithm which is described later with reference to the flow diagram of FIG. 5.

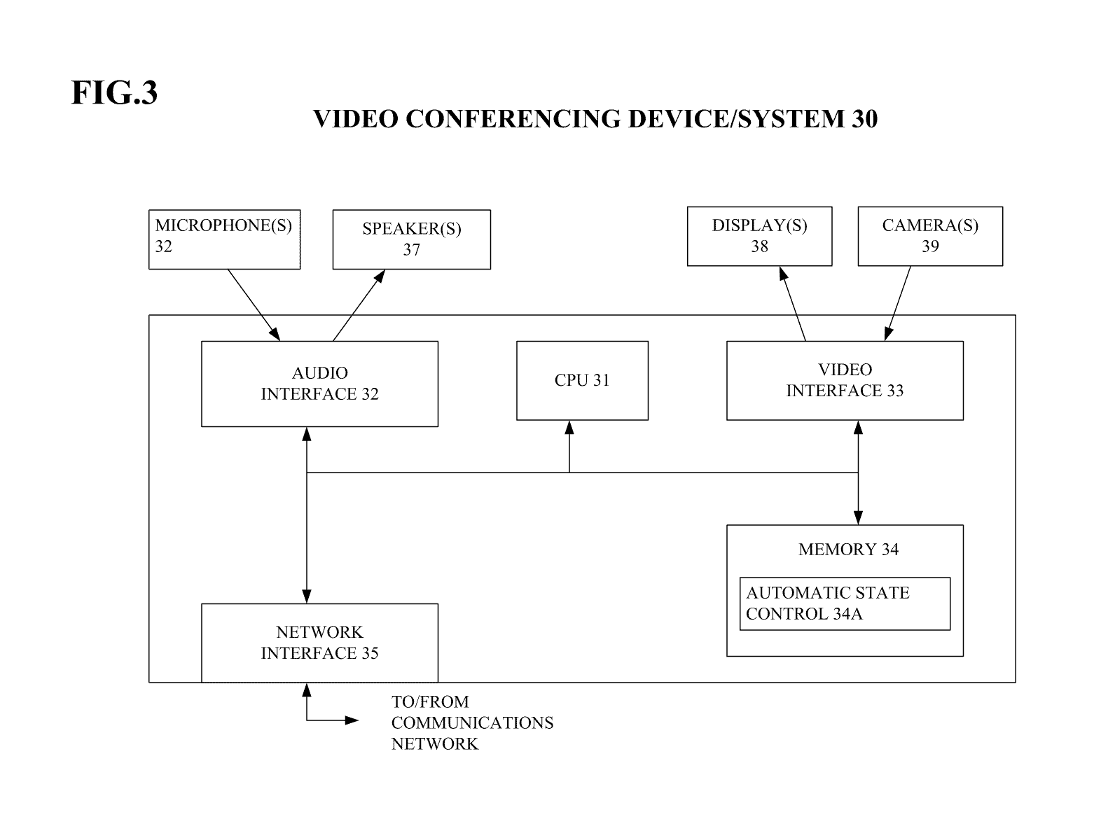

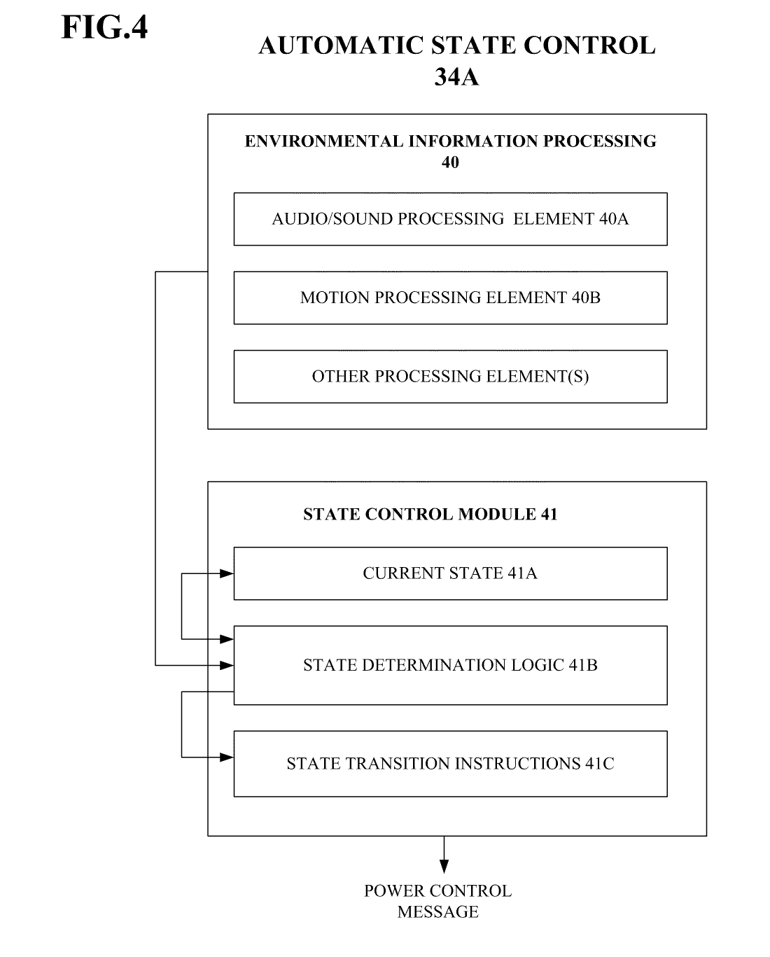

FIG. 3 is a block diagram showing functionality comprising a typical video conferencing device such as the system 10 of FIG. 1 or the device 20 of FIG. 2. A main conferencing device component 30 can be comprised of a central processing unit (CPU) which is responsible for overall control of the conferencing device, an audio interface 32 comprised of an A/D converter and audio codec that operates to receive and process far-end audio to be played of the speaker(s) and to receive and process near end audio information from the microphone(s) 36. The main conferencing device component 30 is also comprised of a video interface 33 that is comprised of a video codec and operates to receive and process far-end video information for display on the monitor 38 and to process near-end video information received from the camera(s) 39. The main conferencing device component 30 also includes a memory 34 for storing applications and other software associated with the operation of the conferencing device 30 and to store automatic state control functionality 34a. And finally, the device component 30 includes a network interface 35 which operates to receive and transmit audio, video and other information from and to a communication network. The communication network can be a local network or a wide area network and in the event that other environmental sensors, such as motion detectors, thermal detectors and light level detectors are connected to the network, environmental information received by these sensors can be received by the video conferencing device for processing. The functional elements of the automatic state control functionality 34a will now be described in some detail with reference to FIG. 4.

As shown in FIG. 4, the automatic state control functionality 34a is generally comprised of an environmental information processing module 40 and a system state control module 41. The environmental information processing module 40 is comprised of one or more functional elements that process the information received by environmental sensors so that this information can be used by the state control module 41. For instance, sound information picked up by one or more of microphones 36 and processed by the audio interface 32 (determines among other things the frequency spectrum of the sound and the sound energy level) is sent to memory 34 where it is temporarily stored during the time it is being operated on by an audio processing element 40a included in the environmental information processing module 40. The audio processing element 40a can examine the sound energy level in different frequency bands to determine whether the sound is being generated inside or outside the room in which it is detected. Sound energy received proximate to its source exhibits a larger proportion of higher-frequency energy (above 10 kHz for example) than far-away sources or sound energy sources that are not in the same room as the conferencing device. Based on the acoustics of the room that the conferencing device is located and experimentation, it is possible to set sound energy levels/thresholds in different frequency bands so that the audio processing element can distinguish between far and near sound. If the audio processing element 40a detects a qualified event (QE), which is a determination that the sound is generated by individuals in the room, then the environmental information processing module 40 generates and sends a message to the state control module 41 indicating that this is the case.

Continuing to refer to FIG. 4. Video information captured by one or more of the cameras 39 and processed by the video interface 33 is sent to memory 34 where it is temporarily stored in the form of pixel information during the time it is being operated on by a motion detection element 40b included in the environmental information processing module 40. The motion detection element 40b includes an algorithm that operates to detect motion in image frames captured by the camera. This motion detection algorithm is described in detail with reference to the logic flow chart in FIG. 5. A qualified event (QE) is identified if the detected motion persists for a preselected number of consecutive frames. The environmental information processing module 40 includes other processing elements not described in any detail here as this functionality is well known to those familiar with video conferencing technology. These elements can be comprised of functionality to process thermal information, light information, information received from motion detectors and other sensor information.

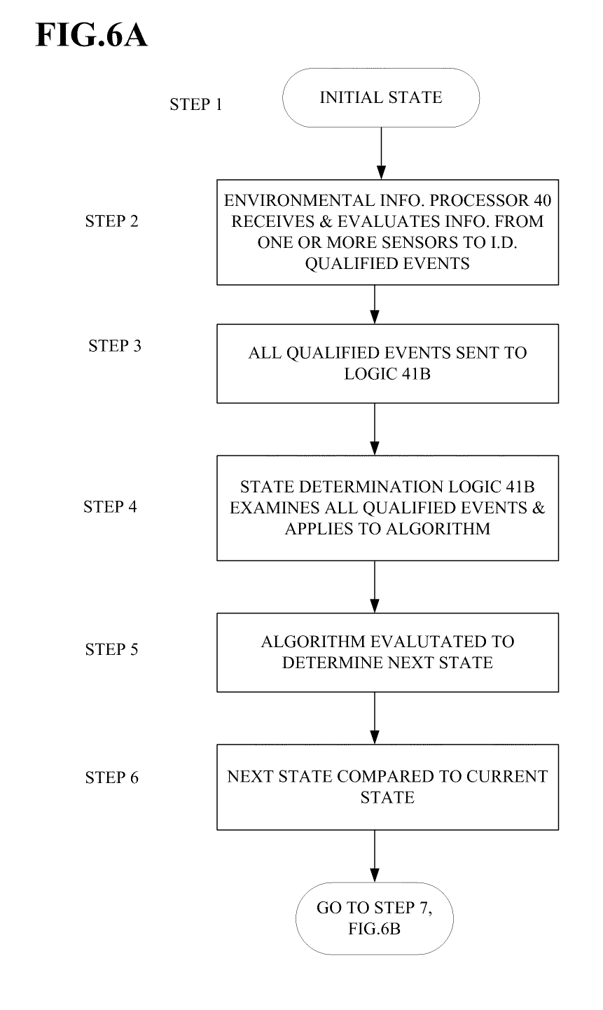

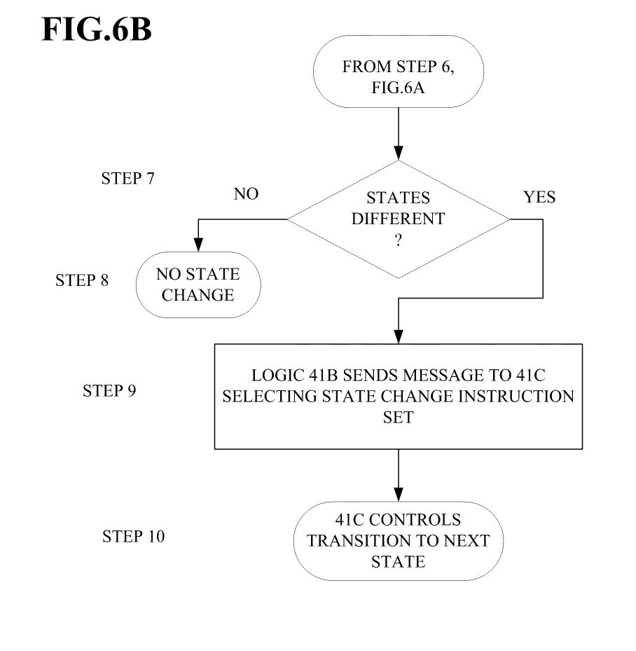

Continuing to refer to FIG. 4, the QEs identified by each processing element comprising the environmental information processing module 40 are sent to the state logic control module 41. Generally, and depending upon the initial powered state of a conferencing device, a qualified event (QE) can be identified by any of the processing elements comprising processing module 40 when the value of the processed environmental information is greater than or equal to or less than or equal to a preselected threshold value. The state logic control module 41 is comprised of a current conferencing system state 41a, logic 41b to determine whether to not to transition to another state and instructions 41c that are sent to the conferencing device that control the power levels of the device components. The current state 41a includes information about the powered state of each of the conferencing systems component parts. This can include whether or not each of the conferencing system components is powered and optionally how much power the conferencing system as a whole is currently using (or as a percentage, how much of the system is powered). This information is updated each time the conferencing system transitions to another state. The logic 41b receives the processed sensor information (QEs) from any one or more of the processing elements comprising the information processing module 40 and stores the QEs for later use. The operation of logic 41b is described in more detail with reference to the logical flow diagram of FIG. 6. And finally, the state transition instruction module 41c is comprised of a plurality of instruction sets one of which is selected according to the results of the state determination logic 41b to control the application of power to each of the conferencing device component parts.

FIG. 5 is a logical flow diagram of the motion detection algorithm employed by the motion detection element 40b described earlier with reference to FIG. 4. Using information captured by a digital camera such as one of the cameras 13 in FIG. 1, this algorithm not only detects motion but also determines the proximity of the motion to a conferencing device, such as conferencing system 10 in FIG. 1 or conferencing device 20 in FIG. 2. In step 1, a current frame of image information is captured by the camera 13 and each of the pixels in the frame is evaluated to determine their gray scale value, and the gray scale value for each pixel is stored. The gray scale value can be any fractional value from zero to one. In order to save processing cycles for other functionality, the gray scale value of all the pixels in a frame need not to be evaluated. Depending upon the resolution of the captured image and the field size of the captured image, more or fewer pixels may need to be evaluated in this manner. Regardless, the number of pixels that are evaluated for a gray scale value for any particular frame size can be determined empirically and the algorithm can be adjusted accordingly. In step 2, the stored gray scale values for each pixel evaluated in step 1 are compared with a stored gray scale value for each corresponding pixel evaluated in a previous frame of information, and in step 3, if a difference in gray scale value between one or more pixels in the current frame and one or more corresponding pixels in the previous frame is evaluated to be greater than a threshold value, then in step 4 the location of the one or more pixels in the current frame evaluated to be different is stored. Otherwise the location of the pixel is not stored. The threshold value used in step 3 is arrived at empirically and is adjustable as necessary depending upon such things as the lighting level in the room in which the conferencing device is locate and other considerations.

Continuing with reference to FIG. 5, in step 5 the pixel location information stored in step 4 is used to identify areas of movement within the frame being evaluated. Each area is defined to include a particular number of pixels and can be referred to as a block of pixels. A block of pixels is defined as a motion block if the number of pixels stored in step 4 and which are included in the block of pixels is greater than a threshold number. So for instance, if a block is defined to include one hundred pixels, and seventy five of the pixels stored in step 4 are contained in the block, and if the threshold number for a motion block is sixty pixels, then this block is determined to be a motion block and the location of this block in the current frame is stored. After all of the blocks of pixels in the current frame are evaluated for motion, in step 6, the number of motion blocks in the current frame are counted and in step 7, if the number of motion blocks in the current frame are counted to be greater than a threshold value, then in step 8 the frame is stored as a motion frame. Otherwise the frame is not stored. As with the other threshold values, the motion block threshold value in step 7 is an adjustable value. The number of motion blocks counted in a frame is used not only to identify motion in the frame but to determine the distance of the motion from the conferencing device camera. This distance value can then be used to determine that the motion is close enough to the conferencing device for the device to transition from one state to another state. So for instance, in the event that there is motion at a distance from the camera that the conferencing system determines is not close enough to apply power to a display device, then the state of the conferencing device remains the same.

Continuing to refer to FIG. 5, in step 9 the store of the last X (a programmable number) number of motion frames is examined, and the number of consecutive motion frames is counted and this number is temporarily stored. In step 10, if the number consecutive frames stored in step 9 is greater than or equal to a threshold value, then in step 11 the conferencing device can transition to another state, which can be applying power to a display device, for instance, or powering on more microphones.

Alternatively, the process described with reference to FIG. 5 can determine that a qualifying motion event occurs by using a video compression algorithm to extract motion vectors and use the motion vectors can be used to determine the level of activity in the field of the camera.

FIG. 6 is a logical flow diagram of a process that can be employed by a conferencing system, such as the conferencing system 10 of FIG. 1, to transition from one powered state to another powered state based on information the system receives from its environment. In step 1, the initial state of system 10 is either a higher powered state (state in which the system is operational) and can be used for audio and video communication with another conferencing system located remote to the system 10 or a lower powered state (state in which the system is minimally operational) and cannot be used for audio or video communication with another conferencing system. In step 2, the environmental information processor 40 receives and evaluates the information received from one or more environmental sensors. If the initial state is a higher powered state, then processor 40 can receive information from all of the environmental sensors connected to the system 10 and if the initial state is a lower powered state, in which only a single microphone and audio codec and/or a single camera and video codec are powered, the processor 40 can receive information from either or both of the microphone and camera. The environmental information collected by each of the different types of sensors (motion, sounds, thermal, camera, etc.) is processed by the appropriate processing element. Some of these elements can receive and process multiple channels of information (inputs from two or more microphones, cameras, etc.). The processing of environmental information differs from environmental processing element to element as described earlier with reference to FIG. 4. Each of the elements can run different processes depending upon the environmental information received, and each of the elements compares the results of the processed environmental information against different threshold levels depending upon the environmental information received. Regardless, the result of the processed environmental information is compared to a threshold value to identify a qualified event (QE). The QE can be identified if the processed result is either greater than and equal to or less than and equal to a threshold value depending upon the current state of the system. In step 3, the identified QEs associated with the environmental information received by each sensor is sent to the state determination logic 41b and temporarily stored for a programmable, predetermined period of time. This period of time can be greater or lesser depending upon how quickly the users would like the system 10 to react to an environmental change that results in a system state transition.

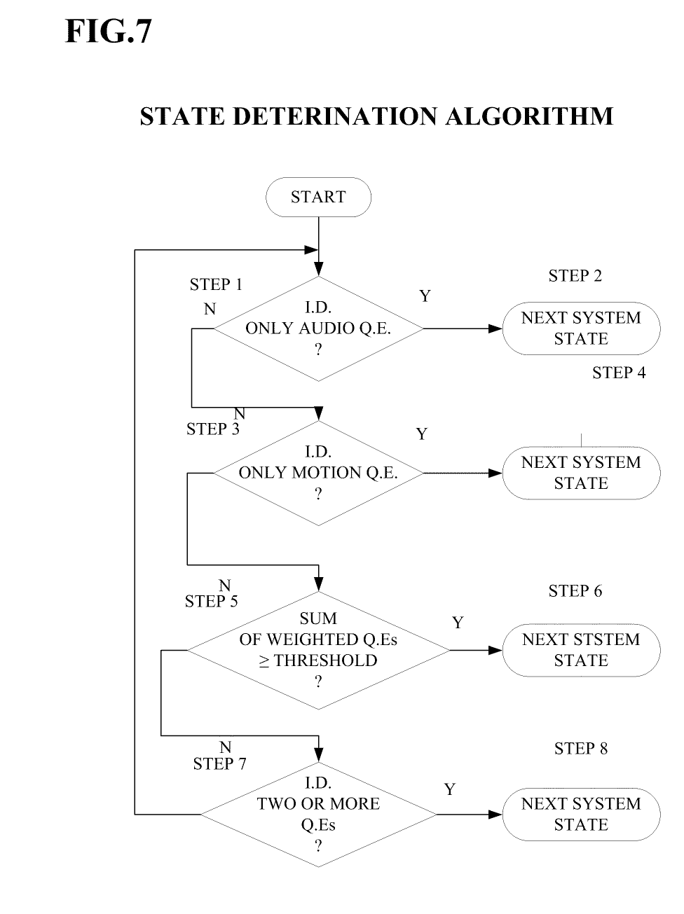

Continuing to refer to FIG. 6, in step 4, the state determination logic 41b examines all of the currently stored QE information and applies this information to a state determination algorithm which is described later with reference to FIG. 7. In step 5, the output of this algorithm is a next system state which is stored temporarily. In step 6, the stored next system state is compared to the current system state 41a and if the states are not different the process proceeds to step 8 and the system 10 does not transition to another state. On the other hand, if in step 7 the current and next states are compared to be different, then the process proceeds to step 9 and the state determination logic 41b sends a message to the state transition instruction module 41c. This message includes a pointer to one set of two or more sets of instructions stored in the state transition instruction module 41c. The state transition instruction module 41c then selects the set of instructions pointed to and uses them to apply or withdraw power from the one or more operational devices associated with conferencing system 10. Depending upon the current state of system 10, the application of the set of instructions identified in step 9 can result in the system 10 transitioning to a lower powered state or to a higher powered state.

FIG. 7 is a logical flow diagram of the state determination algorithm mentioned above with reference to FIG. 6. The conferencing system can initially be in a higher or lower powered state. In step 1, if only an audio QE is identified in step 3 of FIG. 6, the process proceeds to step 2 of FIG. 7 where the next system state can be one in which a camera, all of the microphones, display and codecs are powered, otherwise the process proceeds to step 3 of FIG. 7. In step 3, if only a video motion QE is identified in step 3 of FIG. 6, then the process proceeds to step 4 of FIG. 7 where the next system state can be one in which a display is powered, otherwise the process proceeds to step 5 of FIG. 7. In step 5, if the sum of the detected values of two or more weighted QEs are greater than or equal to a threshold value, then the process proceeds to step 6 of FIG. 7 where the next state can be one in which one or more of the conferencing device component parts are powered down, otherwise the process proceeds to step 7. If in step 7, two or more QEs are detected in step 3 of FIG. 6, then the process proceeds to step 8 where the next system state can be a lower powered state in which one or more component parts are powered down, otherwise the process returns to step 1.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

We claim:

1. A method of controlling the powered state of a conferencing device having a plurality of components, comprising:
evaluating information received from one or more environmental sensors to identify at least one qualified event while the conferencing device is in a current power state;
using the at least one qualified event to determine a next power state;
comparing the current power state to the next power state; and
if the next power state is different than the current power state, the conferencing device transitioning to the next power state by changing the power condition of at least one of the plurality of components of the conferencing device.

2. The method of claim 1 further comprising using the next power state to select one set of transitional instructions from among a plurality of sets of transitional instructions and the conferencing device using the selected set of instructions to transition to the next power state.

3. The method of claim 2 wherein each one of the plurality of sets of transitional instructions is comprised of one or more commands that the conferencing system uses to control the powered state of at least one component part.

4. The method of claim 1 wherein the two or more environmental sensors are a camera, a microphone, a motion detector, a light level detector, and a thermal detector.

5. The method of claim 1 wherein the qualified event is identified as processed environmental information that has a value which is compared to a preselected threshold value.

6. The method of claim 1, wherein at least one qualified event is weighted based on the environmental sensor that provides the information.

7. A method of controlling the powered state of a conferencing device having a plurality of components, comprising:
evaluating information received from an environmental sensor to identify a qualified motion event while the conferencing device is in a lower powered state;
using the qualifying motion event to determine a next power state;
comparing the current power state to the next power state; and
if the next power state is different than the current power state, the conferencing device transitioning to the next power state by changing the power condition of at least one of the plurality of components of the conferencing device.

8. The method of claim 7 further comprising using the next power state to select a set of transitional instructions and the conferencing device using the selected set of instructions to transition to the next power state.

9. The method of claim 8 wherein the set of transitional instructions is comprised of one or more commands that the conferencing system uses to control the powered state of at least one component part.

10. The method of claim 7 wherein the environmental sensor is a camera.

11. The method of claim 7 wherein the qualified event is identified as processed environmental information that is compared to a preselected threshold value.

12. The method of claim 7 wherein the next state is comprised of a display device being powered.

13. A conferencing device, comprising:
a display;
at least one speaker;
a plurality of environmental sensors;
an audio and a video codec;
a network interface; and
a central processor and memory, the memory comprised of a state control module that operates to evaluate environmental information detected by at least one of the environmental sensors to identify a qualified event which is used to determine the next conferencing device power state and comparing the next conferencing device power state to a current conferencing device power state and if the next and the current power states are different, the conferencing device transitioning to the next power state and changing the power condition of at least one of the display, at least one speaker, plurality of environmental sensors, audio and video codec and central processor.

14. The conferencing device of claim 13 wherein the plurality of environmental sensors are any two or more of a camera, a microphone, a motion detector, a light level detector, and a thermal detector.

15. The conferencing device of claim 13 wherein the network interface connects to a wide area or a local area network.

16. The conferencing device of claim 13 wherein the qualified event is identified as processed environmental information that has a value which is compared to a preselected threshold value.
